(19) United States
(12) Patent Application Publication
(10) Pub. No.: US 2018/0189977 A1
(43) Pub. Date: Jul. 5, 2018

(54) LIGHT DETECTOR CALIBRATING A TIME-OF-FLIGHT OPTICAL SYSTEM

(71) Applicant: Analog Devices Global

(72) Inventors: Maurizio Zecchini, San Jose, CA (US); Chao Wang, Milpitas, CA (US); Eoin English, Pallasgreen (IE); Javier Calpe Maravilla, Alegemesi (ES)

(73) Assignee: Analog Devices Global

(21) Appl. No.: 15/395,589

(22) Filed: Dec. 30, 2016

(51) Int. Cl. G06T 7/80; H04N 17/00; G01S 7/497; G01S 17/89

(52) U.S. Cl. CPC G06T 7/85; H04N 17/002; G06T 2207/10012; G01S 17/89; G01S 7/497

(57) ABSTRACT

This disclosure pertains to a system and method for calibrating a time-of-flight imaging system. The system includes a housing that houses light emitter, a light steering device, and a photosensitive element. The system also includes an optical waveguide or reflective element on an inner wall of the housing. The light steering device can be controlled to steer a beam of light from the light emitter to the optical waveguide. The optical waveguide or reflective element can direct the light from a known position on the wall of the housing to the photosensitive element.

### FIELD

This disclosure pertains to systems and methods for calibrating a photosensitive element, and more particularly, to systems and methods for calibrating a time-of-flight (ToF) imaging system.

### BACKGROUND

Optical systems can be configured to measure the depth of objects in a scene. To measure depth of an object, a system controller can set a light steering device to the desired XY point in space. Once the desired XY point is addressed, a system controller triggers the generation of a short pulse driving a light source. At the same time this trigger signal is used to indicate the START of a ToF measurement. The light beam emitted will travel in space until it finds an obstacle reflecting part of the light. This reflected light can be detected by a photosensitive element.

The received light is then amplified providing an electrical pulse fed to an Analog Front End (AFE) determining when the received pulse crosses a determined threshold, in the simplest form with a fast comparator, or correlating the received pulse with the emitted signal.

### SUMMARY

This disclosure pertains to a system and method for calibrating a time-of-flight imaging system. The system includes a housing that houses a light emitter, a light steering device, and a photosensitive element. The light steering device can be controlled to steer a beam of light from the light emitter to the reflective element. The system may also include an optical waveguide or a reflective element on an inner wall of the housing. The optical waveguide or reflective element can direct the light from a known position on the wall of the housing to the photosensitive element or a secondary photosensitive element.

Aspects of the embodiments are directed to an optical head that includes a light emitter; a light steering device; a photosensitive element configured to receive reflected light; an internal optical waveguide or reflective element configured to guide or reflect light from the light steering device to a photosensitive element; and a processing circuit configured to calibrate the optical head based, at least in part, on the light guided or reflected to the photosensitive element from the internal optical waveguide or reflective element.

Aspects of the embodiments are directed to a time-of-flight imaging system that includes an optical head. The optical head includes a light emitter; a light steering device; a photosensitive element configured to receive reflected light; and an optical waveguide residing on an internal wall of the optical head and configured to reflect light from the light steering device to the photosensitive element. The time-of-flight imaging system includes a processor configured to calibrate the optical head based, at least in part, on the light received at the photosensitive element from the optical waveguide; and a controller configured to control the light steering device to steer light emitted from the light emitter.

Aspects of the embodiments are directed to a method for calibrating an imaging system. The method can include receiving, at a first time, a calibration light signal from an optical waveguide or reflective element on an inner wall of an optical head; receiving, at a second time, an object light signal corresponding to light originating from the optical head and reflected from the scene; and calibrating the imaging system based, at least in part, on a time difference between the calibration light signal delay and the delay of the signal reflected by the object.

### BRIEF DESCRIPTION OF THE DRAWINGS

FIG. 1 is a schematic diagram of an example imaging system in accordance with embodiments of the present disclosure.

FIG. 2 is a schematic diagram of an example image steering device in accordance with embodiments of the present disclosure.

FIG. 3A is a schematic diagram of a first view of an optical head in accordance with embodiments of the present disclosure.

FIG. 3B is a schematic diagram of a second view of the optical head in accordance with embodiments of the present disclosure.

FIG. 3C is a schematic diagram of another example embodiment of an optical head in accordance with embodiments of the present disclosure.

FIG. 4 is a schematic illustration of an example pulsing timing for calibrating a time-of-flight imaging system in accordance with embodiments of the present disclosure.

FIG. 5A is a process flow diagram for determining a delay time for an imaging system in accordance with embodiments of the present disclosure.

FIG. 5B is a process flow diagram for determining the distance of an object in accordance with embodiments of the present disclosure

FIG. 6 is a process flow diagram for using a calibration signal to monitor functionality of a light steering device of an imaging system in accordance with embodiments of the present disclosure.

### DETAILED DESCRIPTION

This disclosure describes systems and methods to continuously calibrate Time of Flight (ToF) measurements in a system that uses coherent light transmission, a light steering device, and one or two photosensitive element. The calibration system described herein makes use of an opto-mechanical design to provide a reference reflection that can be measured through the same opto-electronic detection (APD/TIA) circuit or an additional PD. The calibration system described herein can correct variations continuously.

For relatively close distances between the imaging system and the target object, the ToF measurement can be very short. For example a target positioned at 1 m will be detected after 6.67 ns; therefore, delays inherent to the system, such as gate propagation delays, interconnections, and misalignments, can cause errors in the real distance measurement. This delay must be accounted for as a predefined offset performed during system calibration. In addition, the system must be capable of compensating for variations caused by environmental conditions and aging.

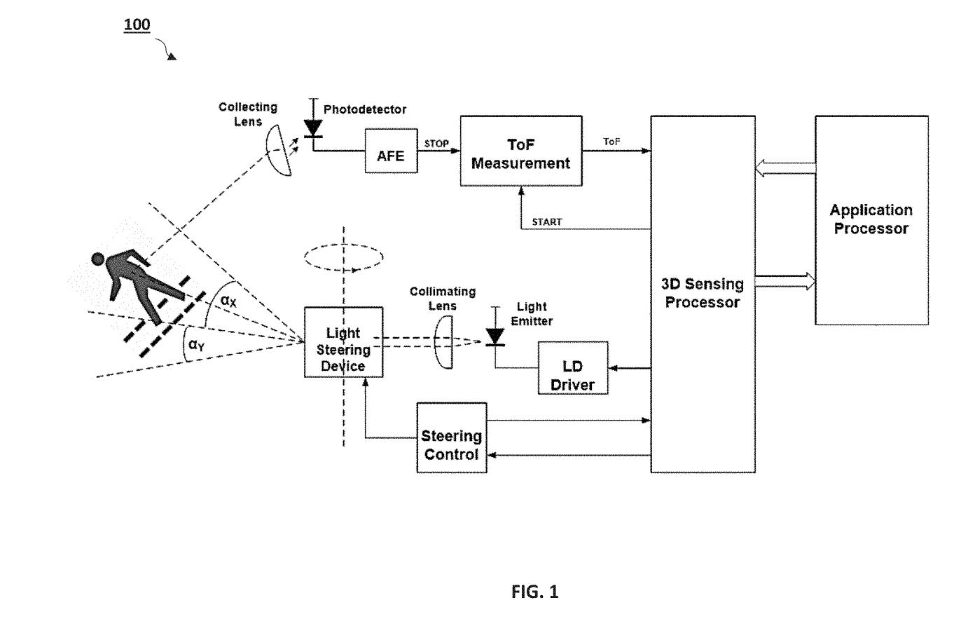

FIG. 1 is a schematic diagram of an example imaging system 100 in accordance with embodiments of the present disclosure. The imaging system 100 includes a light emitter 102. Light emitter 102 can be a light producing device that produces a coherent beam of light that can be in the infrared (IR) range. Some examples of light emitters 102 include laser diodes, solid-state lasers, vertical cavity surface-emitting laser (VCSEL), narrow angle light emitting diodes (LEDs), etc. The imaging system 100 can also include a light emitter driver 104. The light emitter driver 104 can drive the light emitter 102 with a very short (e.g., nanosecond range), high energy pulse. Some examples of light emitter drivers 104 include gallium nitride (GaN) field effect transistors (FETs), dedicated high speed integrated circuits (ICs), application specific integrated circuits (ASICs), etc. In some embodiments, the driver 104 and light emitter 102 can be a single device.

The imaging system 100 can also include a collimating lens 106. The collimating lens 106 makes sure that the angle of each emission of emitted light is as parallel as possible to one another to improve the spatial resolution and to make sure all the emitted light is transferred through the light steering device 108. The light steering device 108 allows collimated light to be steered, in a given field of view (FOV), within a certain angle αX and αY. Light steering device 108 can be a 2D light steering device, where light can be diverted horizontally (110a, αX) and vertically (110b, αY). In embodiments, light steering device 108 can be a 1D device that can steer light only in one direction (αX or αY). Typically a light steering device 108 is electrically controlled to change deflection angle. Some examples of a steering device are: MEMS mirrors, acoustic crystal modulators, liquid crystal waveguides, or other types of light steering devices. In some embodiments, the light steering device 108 can be assembled in a rotating platform (112) to cover up to 360 degrees field of view.

The imaging device 100 can include a light steering device controller and driver 114. The light steering device controller 114 can provide the necessary voltages and signals to control the steering light device deflection angle. The light steering device controller 114 may also use feedback signals to know the current deflection and apply corrections. Typically the light steering device controller 114 is a specialized IC designed for a specific steering device 108.

The imaging system can also include a collecting lens 120. The highly focused light projected in the FOV (110a and 110b) reflects (and scatters) when hitting an object (180), the collecting lens 120 allows as much as possible light to be directed in the active area of the photosensitive element 122. Photosensitive element 122 can be a device that transforms light received in an active area into an electrical signal that can be used for depth measurements. Some examples of photosensitive elements include photodetectors, photodiodes (PDs), avalanche photodiodes (APDs), single-photon avalanche photodiode (SPADs), photomultipliers (PMTs).

An analog front end (AFE) 124 provides conditioning for the electrical signal generated by the photodetector before reaching the analog to digital converter (ADC)/time to digital converter (TDC) elements. Conditioning can include amplification, shaping, filtering, impedance matching and amplitude control. Depending on the photodetector used not all the described signal conditionings are required.

The imaging system 100 can include a time-of-flight (ToF) measurement unit 126. The ToF measurement unit 126 uses a START and STOP signals to measure the ToF of the pulse send from the light emitter 102 to reach the object 180 and reflect back to the photosensitive element 122. The measurement can be performed using a Time to Digital Converter (TDC) or an Analog to Digital Converter (ADC). In the TDC case the time difference between START and STOP is measured by a fast clock. In the ADC case, the photosensitive element is sampled until a pulse is detected or a maximum time is elapsed. In both cases, the ToF measurement unit 126 provides one or more ToF measurements to a 3D sensing processor 130 or application processor (132) for further data processing and visualization/actions.

The STOP signal (e.g., STOP1 or STOP2) can be generated upon detection of reflected light (or, put differently, detection of a light signal can cause the generation of a STOP signal). For example, STOP1 can be generated upon detection of light reflected from an internal reflective element or guided by the optical waveguide; STOP2 can be generated upon detection of light reflected from an object in a scene. In embodiments of a TDC-based system, an analog threshold for light intensity values received by the photosensitive element can be used to trigger the STOP signal. In an ADC-based system, the entire light signal is detected, and a level crossing is determined (e.g., adding filtering and interpolation if needed) or applying a cross-correlation with the emitted pulse.

In embodiments, a timer can be used to establish a fixed STOP time for capturing light reflected from the scene. The timer can allow a STOP to occur if no light is received after a fixed amount of time. In embodiments, more than one object can be illuminated per pixel, and the timer can be used so that receiving the first reflected light signal does not trigger STOP2; instead, all reflected light from one or more objects can be received if received within the timer window.

The 3D sensing processor 130 is a dedicated processor controlling the 3D sensing system operations such as: Generating timings, providing activation pulse for the light emitter, collecting light intensity measurements in a buffer, performing signal processing, sending collected measurements to the application processor, performing calibrations, and/or estimating depth from collected light intensity measurements.

The application processor 132 can be a processor available in the system (e.g. a CPU or baseband processor). The application processor 132 controls the activation/deactivation of the 3D sensing system 130 and uses the 3D data to perform specific tasks such as interacting with the User Interface, detecting objects, navigating. In some embodiments, 3D sensing processor 130 and application processor 132 can be implemented by the same device.

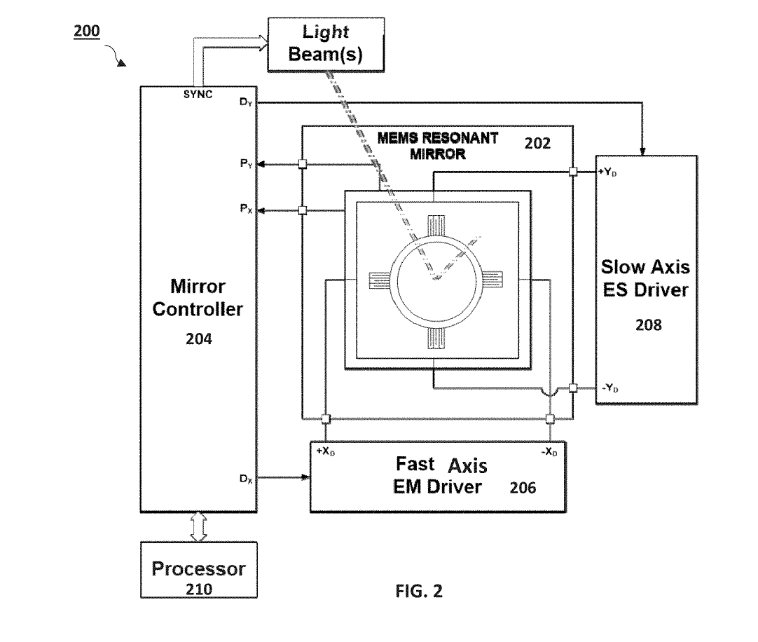

As mentioned above, light steering device 108 can include a MEMS mirror, an acoustic crystal modulator, a liquid crystal waveguides, etc. FIG. 2 illustrates an example MEMS mirror 200. MEMS mirror 200 can be a miniaturized electromechanical device using micro-motors to control the deflection angle of a micro mirror 202 supported by torsion bars. 1D MEMS Mirrors can deflect light along one direction while 2D MEMS mirrors can deflect light along two orthogonal axes. Typical use of 1D MEMS Mirror is a barcode scanner while a 2D MEMS Mirror can be used in pico-projectors, Head-Up-Displays and 3D sensing.

Typically, when operating at video frame rates a 2D MEMS Mirror is designed to operate the fast axis (e.g. the Horizontal pixel scan) in resonant mode while the slow axis (e.g. the Vertical Line Scan) operates in non-resonant (linear) mode. In resonant mode, the MEMS Mirror oscillates at its natural frequency, determined by its mass, spring factor and structure, the mirror movement is sinusoidal and cannot be set to be at one specific position. In non-resonant mode the MEMS Mirror position is proportional to the current applied to the micro-motor, in this mode of operation the mirror can be set to stay at a certain position.

The MEMS micro-motor drive can be electrostatic or electromagnetic. Electrostatic drive is characterized by high driving voltage, low driving current and limited deflection angle. Electromagnetic drive is characterized by low driving voltage, high driving current and wider deflection angle. The fast axis is typically driven by a fast axis electromagnetic actuator 206 (because speed and wide FOV are paramount) while the slow axis is driven by a slow axis electrostatic actuator 208 to minimize power consumption. Depending on the MEMS design and application the driving method can change.

In order to synchronize the activation of the light source according to the current mirror position it is necessary for the MEMS mirror to have position sensing so that the mirror controller 204 can adjust the timings and know the exact time to address a pixel or a line. A processor 210 can provide instructions to the controller 204 based on feedback and other information received from the controller 204. The mirror controller 204 can also provide START signals to the light emitter (as shown in FIG. 1).

In embodiments, the light steering device can include a Liquid Crystal (LC) Waveguide light deflector. The LC waveguide core can be silicon or glass, designed for different wavelength application. The majority of the light will be confined and propagating in the core region when light is coupled into the waveguide.

Liquid crystal layer is designed as upper cladding layer, which has very large electro-optical effect. The refractive index of the liquid crystal layer will change when an external electrical field is applied, which will lead to a change of the equivalent refractive index of the whole waveguide as well.

The LC waveguide includes two regions specified for the horizontal and vertical light deflection, respectively.

For the horizontal deflection, when an electric field is applied, the electrode pattern can create a refractive index change zone with an equivalent prism shape, which can introduce the optical phase difference of the light wavefront, and therefore deflect the propagation direction. The deflection angle is determined by the refractive index change, which is controlled by the electrical field amplitude.

In the vertical region, the light is coupled out to the substrate since the lower cladding is tapered. The coupling angle is determined by the equivalent refractive index of the waveguide and the substrate. The refractive index of the substrate is constant, while the waveguide varies with the applied electric field. Thus, different applied voltages will lead to different vertical and/or horizontal deflection angles.

The output light beam is well collimated. So, no additional collimating optical element is required.

In some embodiments, the light steering device can include an Optical Phase Array (OPA). The OPA is a solid-state technology, analogue to radar, integrating a large number of nano antennas tuned for optical wavelength, the antenna array can dynamically shape the beam profile by tuning the phase for each antenna through thermal changes.

Change in the direction of the light beam is performed by changing the relative timing of the optical waves passing through waveguides and using thermo-optic phase shifting control. The structure of an OPA can be simplified as coherent light coupled into a waveguide running along the side of the optical array, light couples evanescently into a series of branches, having coupling length progressively increasing along the light path in order for each branch to receive an equal amount of power. Each waveguide branch, in turn, evanescently couples to a series of unit cells, with coupling length adjusted in the same way so that all cells in the OPA array receive the same input power.

The array is then sub-divided in a smaller array of electrical contacts with tunable phase delays so the antenna output can be controlled. Temperature is increased when a small current flows through the optical delay line causing a thermo-optic phase shift. Tuning the phase shifts of the antennas can steer and shape the emitted light in the X and Y directions.

An alternative OPA implementation controls both thermo-optic and light wavelength to steer light in X and Y directions, in such implementation thermo-optic is used to control the wavefront of the light through the waveguides while changes in wavelength will produce a different diffraction angle in the grating.

Other examples of light steering devices can include Acoustic Crystal Modulators (ACM), Piezo Steering Mirrors (PZT), Liquid Crystal Optical Phase Modulators (LCOS), etc.

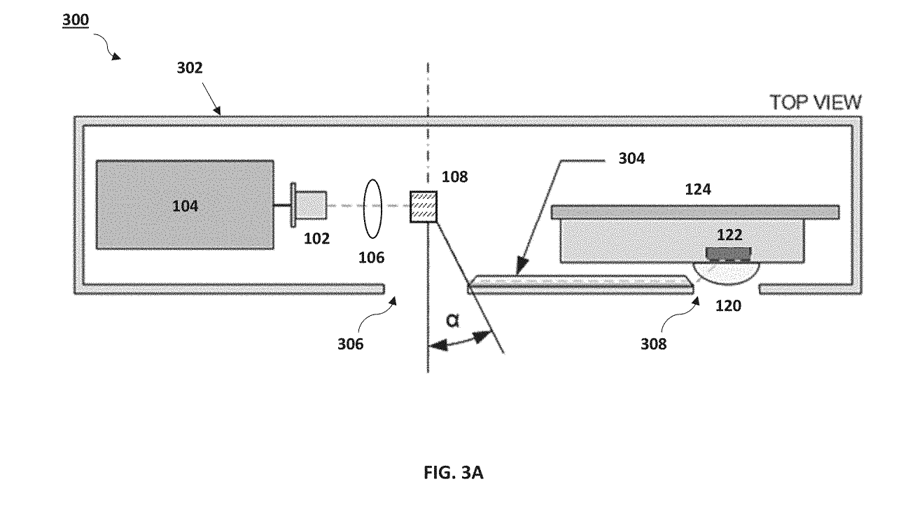

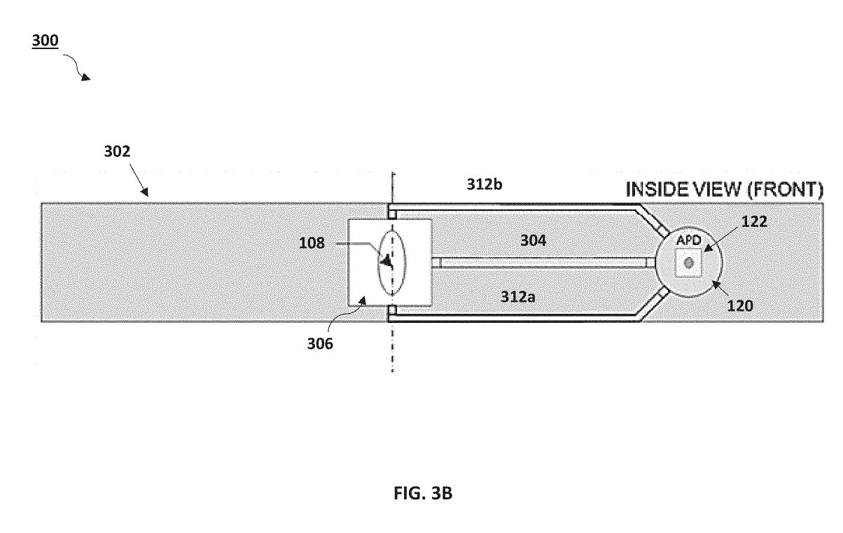

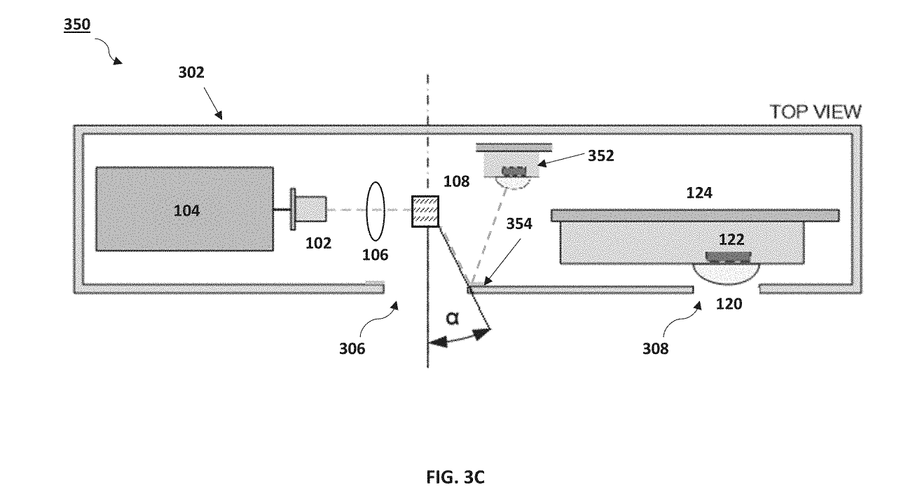

FIG. 3A is a schematic diagram of an optical head 300 that includes a light guide for calibrating an imaging system in accordance with embodiments of the present disclosure. The optical head 300 includes a light emitter 102 (such as a coherent light emitter) driven by a light emitter driver 104, and a collimator 106 to produce a light beam. The optical head 300 also includes a light steering device 108, as described above. The optical head 300 also includes a photosensitive element 122 with converging lens 120 and an analog front end (AFE) 124.

The optical head 300 includes a mechanical housing 302 that contains the light emitter, the photosensitive element 122, as well as other components described in FIG. 3A. The mechanical housing 302 includes an opening 306 for the light coming out from the light steering device 108 and another opening 308 for the light coming in to hit the photosensitive element 122 (through the converging lens 120).

The opening 306 for the light steering device 108 is designed to be large enough to cover the required field of view (FOV) but can be designed (or positioned) to stop light from exiting the housing 302 if the light steering device directs the light beyond the required FOV.

In embodiments, an internal wall of the housing 302 can include optical waveguides, such as waveguide 304, strategically placed, to direct light to the photosensitive element 122 when the light steering device 108 directs the light beyond the required FOV. Waveguides can be placed on a wall to guide light emitted from light emitter that is steered in αX and/or αY directions. FIG. 3B illustrates an inside view of the optical head 300. A light waveguide 312a and light waveguide 312b can be positioned on an internal wall of the housing 302 to direct αY light emissions from the light emitter to the photosensitive element 122.

In operation, light steering device 108 can direct light beyond the required FOV at known times. As an example, if the required FOV for performing image detection is 15 degrees, the light steering device 108 can steer light an additional 5 degrees, for example, for calibration purposes. In some embodiments, the light steering device 108 can steer light an additional 3 degrees, for example, leaving a buffer of 2 degrees for safety or reconfiguring of the light steering device 108. In embodiments, the light steering device 108 can be overdriven beyond the operating range to steer light to the internal housing wall or waveguide 304 (or waveguide 312a or 312b, etc.) for reflecting the light to the photosensitive element 122.

When the light steering device 108 is controlled to steer light to the waveguide 304, 312a, 312b the photosensitive element 122 will detect a calibration signal received by the photosensitive element 122 that is due to internal reflection of light emitted from the light emitter and reflected from waveguide 304 (STOP1); when the light steering device 108 is controlled to steer light within the opening 306 a light pulse is then received by the photosensitive element 122 that is a reflection from a target (STOP2) (assuming an object exists for reflection). Both light pulses are originated from the light emitter 102. Because the STOP1 pulse is caused by a feature placed in an invariable position (i.e., the waveguide 304 on the internal wall of the housing 302, or any point between the opening 306 and opening 308), the delay measured from a START signal timing to a timing at STOP1 can be used to determine the internal delay caused by the imaging system used for calculating ToF measurements. The delay time can be used to faithfully track variations and drift over time in the imaging system.

In embodiments, the calibration signal can be used to monitor whether the steering device 108 is functioning properly. For example, if the calibration signal is not detected as expected, then the imaging system 100 can determine that the light steering device might not be functioning properly. Using a scanning mirror as an example, if the mirror cannot rotate beyond the required FOV angle, then the 3D sensing processor 130 or application specific integrated circuit (ASIC) for imaging processing 132, for example, can determine that the mirror is not functioning properly. In embodiments, the calibration signal can also be used as a failsafe mechanism. For example, if the mirror is not moving, then the calibration signal will not be detected by the photosensitive element 122. The system can determine that the mirror is stuck, and shut off the light emitter 102. In embodiments where the light emitter is a laser or other coherent light source, constant light emissions could be harmful to people or animals. Therefore, in a situation where the calibration is not received as expected (e.g., every 1 second or 10 seconds), the system can terminate light emissions.

In embodiments, the calibration signal can be used to synchronize the mirror movement with the light emission. The detection of the calibration signal can be considered as a calibration-point for determining mirror position. Based on the timing of the detection of the mirror position, the light emitter can synchronize emission of light to impact the mirror at desired times.

FIG. 3C is a schematic diagram of an optical head 350 that includes a reflective coating for calibrating an imaging system in accordance with embodiments of the present disclosure. Optical head 350 is similar to optical head 300. In embodiments, a reflective treatment 354 can be added to the frame of the window 306. A second photosensitive element 352 is positioned in the optical head to detect stray light from the reflective coating (i.e., light reflected back into the housing cavity by the reflective treatment). The light signal detected by the photosensitive element 352 can be used as a calibration signal, as described below.

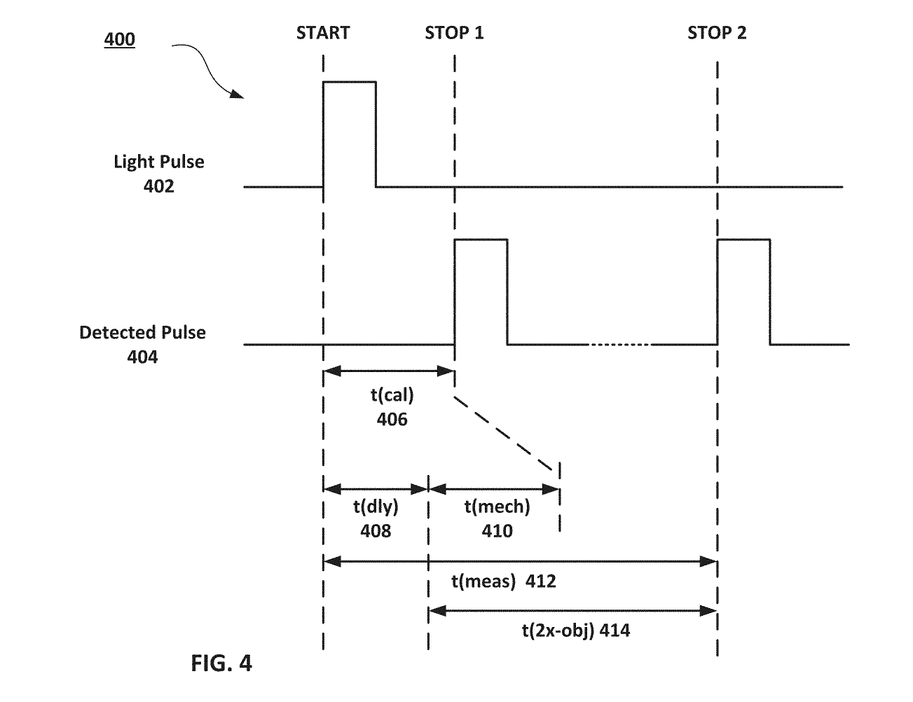

FIG. 4 is a schematic illustration of an example pulsing timing 400 for calibrating a time-of-flight imaging system in accordance with embodiments of the present disclosure. In FIG. 4, a light pulse 402 is emitted at a START time. In normal operating conditions the light steering device points within the opening area 306, light reflected from the target object in the scene will be detected, by the photosensitive element 122, as STOP2 pulse, the time difference between START and STOP2 is the object roundtrip distance measurement tₘₑₐₛ. During calibration the light steering device points outside the opening 306 where the emitted pulse can reach the reflector or the optical waveguide, light will be internally directed to the photosensitive element 122 and received as STOP1 pulse, the time difference between START and STOP1 is the calibration time t_{cal} to be subtracted from tₘₑₐₛ.

The time between the leading edge of the START signal and the leading edge of the STOP1 signal is referred to as t_{cal} 406, which represents a calibration time measurement. The calibration time measurement t_{cal} 406 includes a time delay caused by the internal circuit delay (t_{dly}) 408 and the time light takes to reach the photodetector when the steering device points to the waveguide (t_{mech}) 410. The time t_{mech} 410 is an invariable delay depending on the mechanical design due to the length of the optical waveguide 304, 312a, 312b or the internal light reflector dist_{mech}. The time tₘₑₐₛ 412 is the time measured from the leading edge of START to STOP2 caused by the internal circuit delay (t_{dly}) 408 and the distance of the object to measure multiplied by 2 (t_{2xobj}) 414. Since dist_{mech} is a known design parameter and t_{dly} is measured and equal between target object and calibration measurements, the target object distance can be compensated for circuit time variations and drift t_{dly}.

The following are example relationships that can be used to determine the distance of an object using the above described time measurements:

t_{cal}=t_{mech}+t_{dly}→t_{cal} is the time between START and STOP1;

$${t}_{mech} = \frac{{dist}_{mech}}{c} -> {dist}_{mech}$$

is known and invariable distance between a point on the internal housing of the optical head and the photodetector; c is the speed of light; Substituting t_{mech};

$${t}_{dly} = {t}_{cal} - \frac{{dist}_{mech}}{c} ;$$

$${t}_{meas} = {t}_{2 xobj} - {t}_{dly} -> START to STOP 2 measurement ;$$

$${dist}_{obj} = \frac{( {t}_{meas} - {t}_{dly} )}{2} * c -> Substituting {t}_{dly} \text{:}$$

$${dist}_{obj} = \frac{{t}_{meas} * c - {t}_{cal} * c + {dist}_{mech}}{2}$$

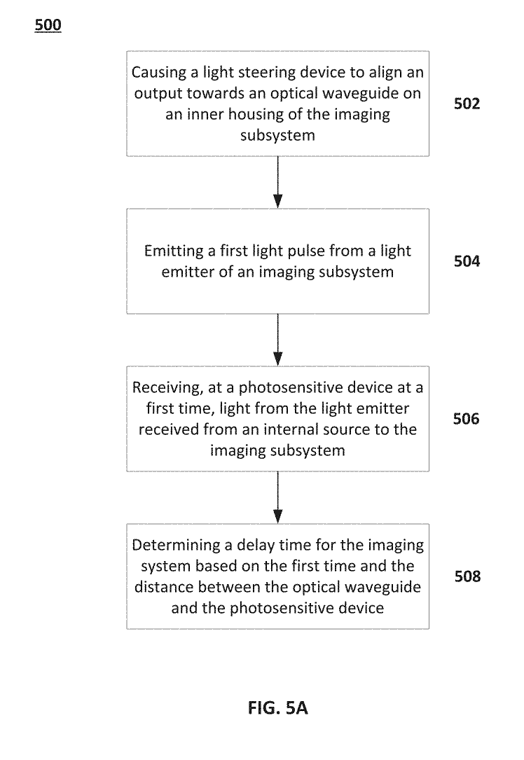

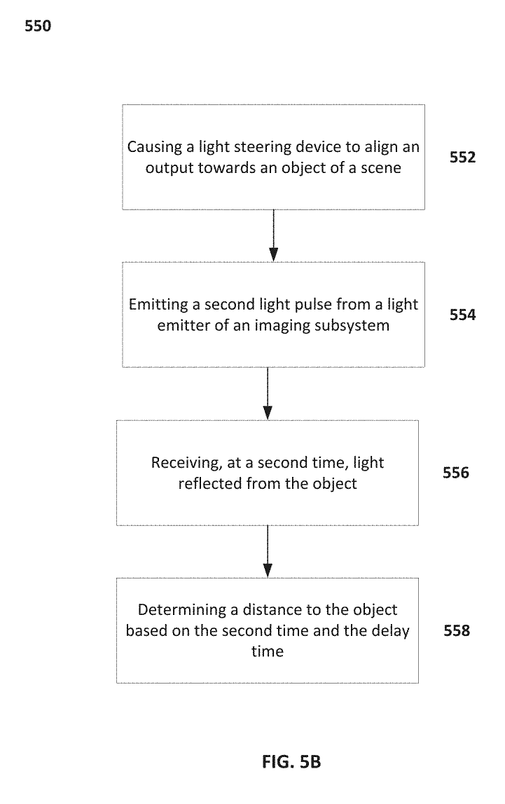

FIG. 5A is a process flow diagram 500 for calibrating an imaging system in accordance with embodiments of the present disclosure. A light steering device can be driven beyond a predetermined required field of view (FOV) to align an output towards an optical waveguide on an inner wall of the optical head (502). The light steering device can be preconfigured to over-steer prior to the first light pulse being emitted. At predetermined intervals, the light steering device will steer light to the internal wall of the optical head housing. As mentioned above, the optical head housing can include an optical waveguide to guide the light from the light steering device to a photosensitive element. A first light pulse can be emitted from a light emitter of an optical head (504). The first light pulse can be emitted at a START time.

The first light pulse can be detected by a photosensitive device (506). The first light pulse can be directed to the photosensitive element by a waveguide. The first light pulse can be received at a second time (e.g., triggering a STOP1 time).

A processor of the imaging system can determine a delay time based on the difference between the STOP1 time and the START time and the time it takes for the light pulse to traverse a light path between an output of the optical waveguide and the photosensitive element (508).

FIG. 5B is a process flow diagram 550 for determining the distance of an object in accordance with embodiments of the present disclosure. The light steering device can be controlled to align an output towards an object of a scene (552). The light emitter can emit a second light pulse towards the light steering device (554). The photosensitive element can receive the reflection of the object at a second time (556). The processor of the imaging system can determine a distance of the object based on the second time and the delay time determined in process flow 500 (558).

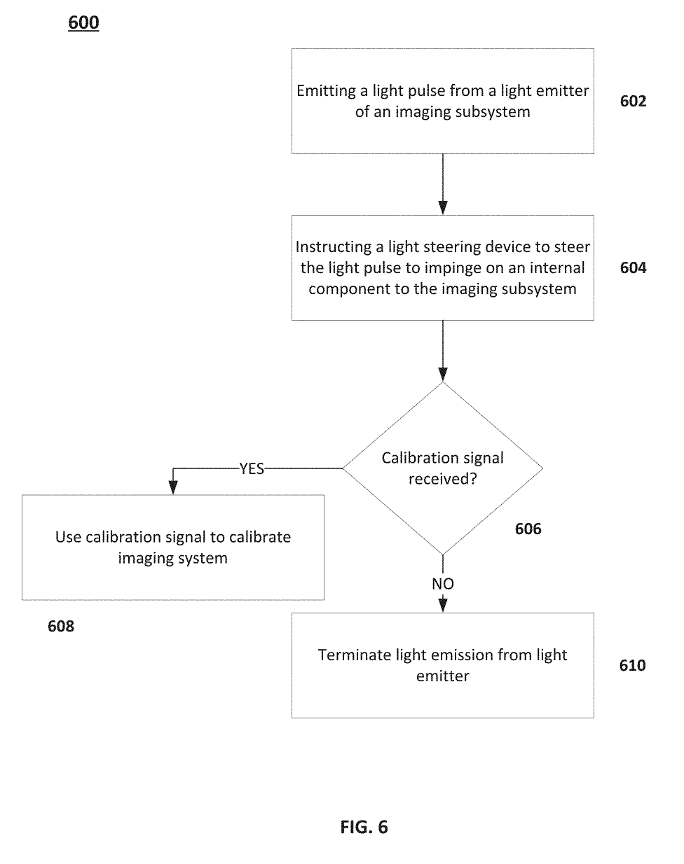

FIG. 6 is a process flow diagram 600 for monitoring the functionality of a light steering device of an imaging system in accordance with embodiments of the present disclosure. A light pulse can be emitted from a light emitter of an optical head (602). A light steering device can be instructed to steer light beyond a predetermined required field of view (FOV) to steer emitted light to an internal wall of the optical head (604). The light steering device can be preconfigured to over-steer prior to the first light pulse being emitted. At predetermined intervals, the light steering device will steer light to the internal wall of the optical head housing. As mentioned above, the optical head housing can include an optical waveguide to guide the light from the light steering device to a photosensitive element.

A processor, an AFE, or other image processing device, can determine whether a calibration signal was received by the photosensitive element (606) whenever it is expected. If the calibration signal is received, then the processor can use the calibration signal to calibrate the imaging system (608). If the calibration signal is not received, then the processor can instruct the light emitter to shut down (610).

What is claimed is:

1. An optical head comprising:
a light emitter;
a light steering device;
a photosensitive element configured to receive reflected light;
a reflective means on an internal wall of the optical head, the optical waveguide configured to reflect light from the light steering device to the photosensitive element; and
a processing circuit configured to calibrate the optical head based, at least in part, on the light guided to the photosensitive element from the optical waveguide.

2. The optical head of claim 1, wherein the light steering device is configured to steer light received from the light emitter to the optical waveguide.

3. The optical head of claim 1, wherein the reflective element comprises an optical waveguide.

4. The optical head of claim 1, wherein the reflective element comprises a reflective coating on a frame of an opening within an optical path of the light steering device, and
wherein the photosensitive element is positioned in the optical head to receive light reflected from the reflective coating.

5. The optical head of claim 1, wherein the processing circuit is configured to calibrate the optical head based on a first light signal received at the photosensitive element from the optical waveguide and based on a second light signal received at the photosensitive element from an object in a scene.

6. The optical head of claim 1, wherein the light steering device comprises one of a scanning micro-mirror, liquid crystal waveguide, or optical parametric amplifier.

7. The optical head of claim 1, further comprising a housing, the housing comprising:
a first opening configured to permit light from the light steering device to exit the optical head;
a second opening configured to permit light to enter the optical head and be received by the photosensitive element; and
an internal housing wall between the first opening and the second opening, wherein the optical waveguide resides on the internal housing wall.

8. A time-of-flight imaging system comprising:
an optical head comprising:
a light emitter;
a light steering device;
a photosensitive element configured to receive reflected light; and
an optical waveguide residing on an internal wall of the optical head and configured to reflect light from the light steering device to the photosensitive element;
a processor configured to calibrate the optical head based, at least in part, on the light received at the photosensitive element from the optical waveguide; and
a controller configured to control the light steering device to steer light emitted from the light emitter.

9. The time-of-flight imaging system of claim 8, wherein the controller is configured to cause the light steering device to steer light originating from the light emitter to the optical waveguide or internal optical waveguide at predetermined time intervals.

10. The time-of-flight imaging system of claim 8, wherein the image processor is configured to estimate depth of an object of a scene based, at least in part, on light reflected from the object and received by the photosensitive element.

11. The time-of-flight imaging system of claim 8, wherein the processing circuit is configured to calibrate the optical head based on a first light signal received at the photosensitive element from the optical waveguide and based on a second light signal received at the photosensitive element from an object in a scene.

12. The time-of-flight imaging system of claim 8, wherein the light steering device comprises a scanning mirror, and wherein the controller is configured to cause the scanning mirror to deflect to a predetermined deflection angle to steer light originating from the light emitter to the optical waveguide.

13. The time-of-flight imaging system of claim 8, wherein the optical head further comprises a housing, the housing comprising:
a first opening configured to permit light from the light steering device to exit the optical head;
a second opening configured to permit light to enter the optical head and be received by the photosensitive element; and
an internal housing wall between the first opening and the second opening, wherein the optical waveguide resides on the internal housing wall.

14. A method for calibrating an imaging system, the method comprising:
emitting a pulse of light at a first time towards an optical waveguide on an inner wall of an optical head of the imaging system;
receiving, at photodetector, at a second time, a calibration light signal from the optical waveguide;
determining a calibration time based on a difference between the first time and the second time;
determining a mechanical time difference based on a distance between the optical waveguide and the photodetector; and
determining a delay time for the optical head based, at least in part, on the calibration time and the mechanical time.

15. The method of claim 15, further comprising:
emitting a pulse of light towards an object of a scene;
receiving a reflected light from the object at a third time; and
determining a distance of the object from the optical head based, at least in part, on the third time and the delay time.

16. The method of claim 15, further comprising:
causing a light steering device to steer a light pulse to the optical waveguide prior to emitting the pulse of light at the first time; and
causing the light steering device to steer a second light pulse to the object of the scene prior to emitting the pulse of light towards the scene.

17. The method of claim 14, further comprising:
determining that the calibration light signal has not been received at an expected time period;
determining that the light steering device is not functioning based, at least in part, on the calibration light signal not being received; and
terminating the light emitter based on determining that the light steering device is not functioning.

18. The method of claim 14, further comprising:
receiving the calibration light signal;
determining a time that the calibration light signal was received;
correlating the time that the calibration light signal was received with a position of the light steering device; and
synchronizing a light emitter with the light steering device based on the calibration light signal.

19. The method of claim 14, wherein determining a mechanical time difference comprises determining an amount of time for light to traverse a light path between the output of the optical waveguide and the photosensitive element.

20. The method of claim 14, wherein the distance between the optical waveguide and the photodetector is a predetermined distance.
